(19) United States
(12) Patent Application Publication
(10) Pub. No.: US 2026/0153841 A1
(43) Pub. Date: Jun. 4, 2026

(54) ARTIFICIAL INTELLIGENCE-BASED METHOD AND SYSTEM FOR CONTROLLING PLANT CULTIVATION

(71) Applicant: LG ELECTRONICS INC., Seoul (KR)

(72) Inventor: Jaehong KIM, Seoul (KR)

(73) Assignee: LG ELECTRONICS INC., Seoul (KR)

(21) Appl. No.: 19/122,582

(22) PCT Filed: Oct. 21, 2022
(86) PCT No.: PCT/KR2022/016192

§ 371 Date: Apr. 18, 2025

(51) Int. Cl. G05B 13/02; A01G 7/00; G05B 13/04; G06Q 50/02

(52) U.S. Cl. CPC G05B 13/0265; G05B 13/048; G06Q 50/02

(57) ABSTRACT

Disclosed are an artificial intelligence-based method and system for controlling plant cultivation. An artificial intelligence-based method for controlling plant cultivation in a server according to at least one of various embodiments of the present disclosure may comprise the steps of: generating a plant growth prediction model; detecting a first event; acquiring an image of a target plant in a plant cultivation device; generating cultivation information of the target plant with respect to the detected first event and the acquired image on the basis of the plant growth prediction model; and controlling output of the generated cultivation information of the target plant.

### TECHNICAL FIELD

The present disclosure relates to a method and system of controlling plant cultivation based on artificial intelligence.

### BACKGROUND TECHNOLOGY

Along with the development of digital technology or communication technology, the development of Information and Communications Technology (ICT) technology is remarkable.

In particular, much research is being conducted on artificial intelligence technology, and attempts are being made to apply the artificial intelligence technology to various fields.

Recently, interest in companion plants has been gradually increasing following companion animals.

However, in the past, small-sized plant cultivation machines were provided so that ordinary people could cultivate plants, but it is not easy for non-experts to cultivate companion plants without problems using only a plant cultivation machine, and thus plant cultivation often fails.

This reduces interest in companion plant cultivation and causes dissatisfaction.

### DETAILED DESCRIPTION OF THE INVENTION

### Technical Problem

The problem that the present disclosure seeks to solve is to provide an artificial intelligence-based plant cultivation control method and system.

Another problem that the present disclosure seeks to solve is to provide various plant cultivation control information, including information on growth prediction of target plants based on artificial intelligence, to provide convenience in using a plant cultivation machine.

Another problem that the present disclosure seeks to solve is to provide a service that provides users with not only an automatic control function of a plant cultivation machine but also prediction information on the growth process of a target plant, so as to induce enjoyment and interest in using a plant cultivation machine or plant cultivation, and to enable a virtual experience.

The problems that the present disclosure seeks to solve are not limited to the problems mentioned above, and other problems that are not mentioned can be clearly understood by those skilled in the art from the description below.

### Technical Solution

A method for plant cultivation based on artificial intelligence in a server according to at least one of the various embodiments of the present disclosure for solving the above-described problem may include generating a plant growth prediction model; detecting a first event; obtaining an image of a target plant in a plant cultivation device; generating cultivation information of a target plant for the detected first event and the obtained image based on the plant growth prediction model; and controlling an output of the generated cultivation information of the target plant.

A system for controlling plant cultivation based on artificial intelligence according to at least one of the various embodiments of the present disclosure may include a plant cultivation device; and a computing device communicating with the plant cultivation device and transmit and receive a signal, wherein the computing device comprises a processor that generates a plant growth prediction model, obtains, when an event is detected, an image of a target plant in the plant cultivation device, generates cultivation information of the target plant for the detected event and the obtained image based on the plant growth prediction model, and controls an output of the generated cultivation information of the target plant.

Other specific details of the present disclosure are included in the detailed description and drawings.

### Effects of the Invention

According to at least one of the various embodiments of the present disclosure, there is an effect of providing an artificial intelligence-based plant cultivation control method and system.

According to at least one of the various embodiments of the present disclosure, there is an effect of improving the user's convenience of using a plant cultivation machine through various plant cultivation control information including information on growth prediction of a target plant based on artificial intelligence.

According to at least one of the various embodiments of the present disclosure, a virtual experience service can be provided based on an automatic control function of a plant cultivation machine and prediction information on the growth process of a target plant, so that even non-experts can easily and conveniently use a plant cultivation machine, and there is an effect of inducing enjoyment and interest in plant cultivation.

### BRIEF DESCRIPTION OF DRAWINGS

FIG. 1 illustrates an AI device according to an embodiment of the present disclosure.

FIG. 2 illustrates an AI server according to an embodiment of the present disclosure.

FIG. 3 illustrates an AI system according to an embodiment of the present disclosure.

FIG. 4 illustrates an AI device according to another embodiment of the present disclosure.

FIG. 5 is a diagram illustrating an AI-based plant cultivation control system according to an embodiment of the present disclosure.

FIG. 6 is a block diagram illustrating an operation of the processor of FIG. 5.

FIG. 7 is a block diagram illustrating an operation of the learning unit of FIG. 6.

FIGS. 8 to 12 are flowcharts illustrating the AI-based plant cultivation control method according to an embodiment of the present disclosure.

FIGS. 13 to 15 are drawings illustrating a user interface related to an AI-based plant cultivation control according to an embodiment of the present disclosure.

FIG. 16 is a drawing illustrating a scenario for providing AI-based target plant cultivation information according to an embodiment of the present disclosure.

### BEST MODEL

Hereinafter, embodiments related to the present invention will be described in more detail with reference to the drawings. The suffixes “module” and “part” used for components in the following description are given or used interchangeably only for the convenience of writing a specification, and do not have distinct meanings or roles in themselves.

An artificial intelligence (AI) refers to a field that studies artificial intelligence or a methodology for creating it, and Machine Learning (Machine Learning) refers to a field that defines various problems in the field of artificial intelligence and studies a methodology for solving them. Machine Learning is also defined as an algorithm that improves the performance of a task through continuous experience.

An artificial neural network (ANN) is a model used in machine learning, and can refer to the entire model with problem-solving capabilities that consists of artificial neurons (nodes) that form a network by combining synapses. An artificial neural network can be defined by a connection pattern between neurons in different layers, a learning process that updates model parameters, and an activation function that generates output values.

An artificial neural network can include an input layer, an output layer, and optionally one or more hidden layers. Each layer includes one or more neurons, and an artificial neural network can include synapses that connect neurons to neurons. In an artificial neural network, each neuron can output the function value of the activation function for the input signals, weights, and biases input through the synapse.

Model parameters refer to parameters determined through learning, including the weights of synaptic connections and the biases of neurons. In addition, hyperparameters refer to parameters that must be set before learning in machine learning algorithms, including the learning rate, number of repetitions, mini-batch size, and initialization function.

The purpose of learning in an artificial neural network can be seen as determining model parameters that minimize the loss function. The loss function can be used as an indicator to determine the optimal model parameters during the learning process of an artificial neural network.

Machine learning can be classified into supervised learning, unsupervised learning, and reinforcement learning depending on the learning method.

Supervised learning refers to a method of training an artificial neural network when labels for training data are given, and the labels can refer to the correct answer (or result value) that the artificial neural network must infer when training data is input to the artificial neural network. Unsupervised learning can refer to a method of training an artificial neural network when labels for training data are not given. Reinforcement learning can refer to a learning method that trains an agent defined in a certain environment to select an action or action sequence that maximizes cumulative reward in each state.

Among artificial neural networks, machine learning implemented with a deep neural network (DNN) that includes multiple hidden layers is also called deep learning, and deep learning is a part of machine learning. Hereinafter, machine learning is used to mean including deep learning.

Object detection models using machine learning include the single-stage You Only Look Once (YOLO) model and the two-stage Faster Regions with Convolution Neural Networks (R-CNN) model.

You Only Look Once (YOLO) model is a model that can predict objects and the location of the objects in an image by looking at the image only once.

You Only Look Once (YOLO) model divides the original image into grids of the same size. Then, for each grid, the number of bounding boxes designated in a predefined shape centered on the center of the grid is predicted, and the reliability is calculated based on this.

After that, whether the image contains an object or only the background is included, and the location with high object reliability can be selected to identify the object category.

Faster Regions with Convolution Neural Networks (R-CNN) model is a model that can detect objects faster than the RCNN model and Fast RCNN model.

The Faster Regions with Convolution Neural Networks (R-CNN) model is explained in detail.

First, a feature map is extracted from the image through the Convolution Neural Network (CNN) model. Based on the extracted feature map, multiple regions of interest (RoI) are extracted. A RoI pooling is performed for each region of interest.

The RoI pooling is a process of setting a grid to match the pre-determined H×W size of the feature map on which the region of interest is projected, extracting the largest value for each cell included in each grid, and extracting a feature map having the size of H×W.

A feature vector is extracted from a feature map having the size of H×W, and object identification information can be obtained from the feature vector.

An extended Reality (XR) is a general term for a Virtual Reality (VR), an Augmented Reality (AR), and a Mixed Reality (MR). The VR technology provides objects or backgrounds in the real world only as CG images, the AR technology provides virtual CG images on top of real object images, and the MR technology is a computer graphics technology that mixes and combines virtual objects in the real world.

The MR technology is similar to the AR technology in that it shows real objects and virtual objects together. However, there is a difference in that while the AR technology uses virtual objects to complement real objects, the MR technology uses virtual objects and real objects with equal characteristics.

The XR technology can be applied to a Head-Mounted Display (HMD), a Head-Up Display (HUD), mobile phones, tablet PCS, laptops, desktops, TVs, a digital signage, etc., and devices to which the XR technology is applied can be called XR devices.

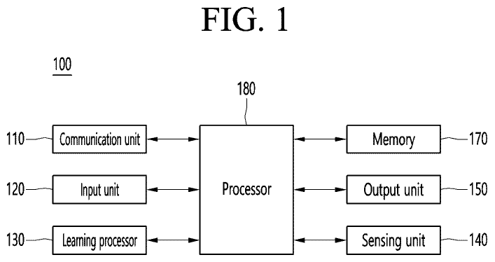

FIG. 1 illustrates an AI device 100 according to an embodiment of the present disclosure.

The AI device 100 may be implemented as a fixed device or a movable device, such as a TV, a projector, a mobile phone, a smart phone, a desktop computer, a laptop, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, etc.

Referring to FIG. 1, the terminal 100 may include a communication unit 110, an input unit 120, a learning processor 130, a sensing unit 140, an output unit 150, a memory 170, and a processor 180.

The communication unit 110 can transmit and receive data with external devices such as other AI devices 100a to 100e or AI servers 200 using wired and wireless communication technology. For example, the communication unit 110 can transmit and receive sensor information, user input, learning models, control signals, etc. with external devices.

At this time, the communication technologies used by the communication unit 110 include Global System for Mobile communication (GSM), Code Division Multi Access (CDMA), Long Term Evolution (LTE), 5G, Wireless LAN (WLAN), Wireless-Fidelity (Wi-Fi), Bluetooth™, Radio Frequency Identification (RFID), Infrared Data Association (IrDA), ZigBee, Near Field Communication (NFC), etc.

The input unit 120 can obtain various types of data.

At this time, the input unit 120 may include a camera for inputting a video signal, a microphone for receiving an audio signal, a user input unit for receiving information from a user, etc. Here, the camera or microphone may be treated as a sensor, and the signal obtained from the camera or microphone may be referred to as sensing data or sensor information.

The input unit 120 may obtain input data to be used when obtaining output using learning data for model learning and a learning model. The input unit 120 may obtain unprocessed input data, and in this case, the processor 180 or the learning processor 130 may extract input features as preprocessing for the input data.

The learning processor 130 may use the learning data to learn a model composed of an artificial neural network. Here, the learned artificial neural network may be referred to as a learning model. The learning model can be used to infer a result value for new input data that is not learning data, and the inferred value can be used as a basis for judgment to perform a certain action.

At this time, the learning processor 130 can perform AI processing together with the learning processor 240 of the AI server 200.

At this time, the learning processor 130 can include a memory integrated or implemented in the AI device 100. Alternatively, the learning processor 130 can be implemented using a memory 170, an external memory directly coupled to the AI device 100, or a memory maintained in an external device.

The sensing unit 140 can obtain at least one of internal information of the AI device 100, information about the surrounding environment of the AI device 100, and user information using various sensors.

At this time, the sensors included in the sensing unit 140 include proximity sensors, light sensors, acceleration sensors, magnetic sensors, gyro sensors, inertial sensors, RGB sensors, IR sensors, fingerprint recognition sensors, ultrasonic sensors, light sensors, microphones, lidar, radar, etc.

The output unit 150 can generate output related to vision, hearing, or touch.

At this time, the output unit 150 can include a display unit that outputs visual information, a speaker that outputs auditory information, a haptic module that outputs tactile information, etc.

The memory 170 can store data that supports various functions of the AI device 100. For example, the memory 170 can store input data, learning data, learning models, learning history, etc. acquired from the input unit 120.

The processor 180 can determine at least one executable operation of the AI device 100 based on information determined or generated using a data analysis algorithm or a machine learning algorithm. Then, the processor 180 can control the components of the AI device 100 to perform the determined operation.

To this end, the processor 180 can request, search, receive, or utilize data from the learning processor 130 or the memory 170, and control the components of the AI device 100 to perform a predicted operation or an operation determined to be desirable among the at least one executable operation.

At this time, if the processor 180 requires linkage with an external device to perform the determined operation, the processor 180 can generate a control signal for controlling the external device and transmit the generated control signal to the external device.

The processor 180 can obtain intention information for a user input and determine the user's requirement based on the obtained intention information.

At this time, the processor 180 may obtain intention information corresponding to the user input by using at least one of the Speech To Text (STT) engine for converting voice input into a string or the Natural Language Processing (NLP) engine for obtaining intention information of natural language.

At this time, at least one of the STT engine or the NLP engine may be configured with an artificial neural network that is at least partially learned according to a machine learning algorithm. In addition, at least one of the STT engine or the NLP engine may be learned by the learning processor 130, learned by the learning processor 240 of the AI server 200, or learned by distributed processing of these.

The processor 180 may collect history information including the operation content of the AI device 100 or the user's feedback on the operation, and store it in the memory 170 or the learning processor 130, or transmit it to an external device such as the AI server 200. The collected history information can be used to update the learning model.

The processor 180 can control at least some of the components of the AI device 100 to drive the application program stored in the memory 170. Furthermore, the processor 180 can operate two or more of the components included in the AI device 100 in combination with each other to drive the application program.

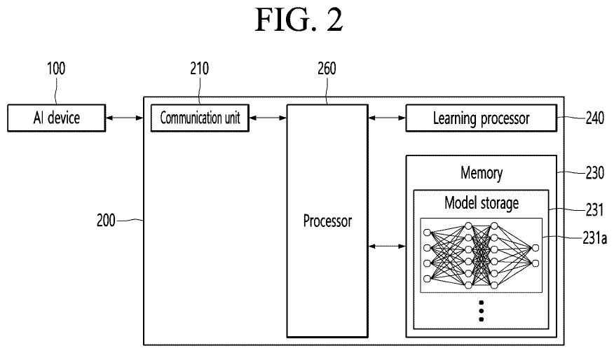

FIG. 2 illustrates an AI server 200 according to an embodiment of the present disclosure.

Referring to FIG. 2, the AI server 200 may mean a device that trains an artificial neural network using a machine learning algorithm or uses a trained artificial neural network. Here, the AI server 200 may be composed of multiple servers to perform distributed processing, and may be defined as a 5G network. In this case, the AI server 200 may be included as a part of the AI device 100 and may perform at least a part of the AI processing together.

The AI server 200 may include a communication unit 210, a memory 230, a learning processor 240, a processor 260, etc.

The communication unit 210 may transmit and receive data with an external device such as the AI device 100.

The memory 230 may include a model storage unit 231. The model storage unit 231 can store a model (or artificial neural network, 231a) being learned or learned through the learning processor 240.

The learning processor 240 can use learning data to learn the artificial neural network 231a. The learning model can be used while being loaded on the AI server 200 of the artificial neural network, or can be loaded on an external device such as an AI device 100 and used.

The learning model can be implemented by hardware, software, or a combination of hardware and software. If part or all of the learning model is implemented by software, one or more instructions constituting the learning model can be stored in the memory 230.

The processor 260 can infer a result value for new input data using the learning model, and generate a response or control command based on the inferred result value.

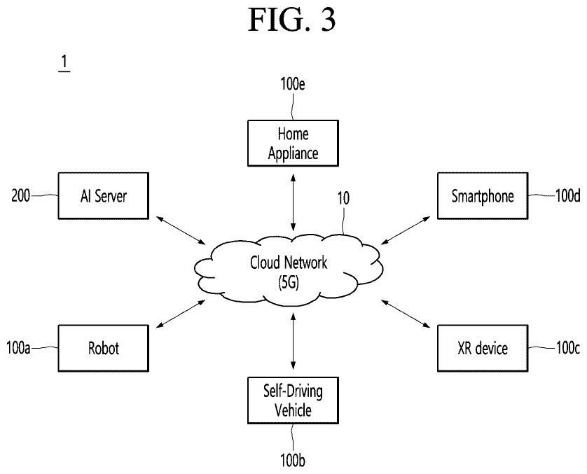

FIG. 3 illustrates an AI system 1 according to an embodiment of the present disclosure.

Referring to FIG. 3, the AI system 1 is connected to at least one of an AI server 200, a robot 100a, an autonomous vehicle 100b, an XR device 100c, a smartphone 100d, or an appliance 100e with a cloud network 10. Here, the robot 100a, the autonomous vehicle 100b, the XR device 100c, the smartphone 100d, or the appliance 100e to which AI technology is applied may be referred to as an AI device 100a to 100e.

The cloud network 10 may mean a network that constitutes part of a cloud computing infrastructure or exists within a cloud computing infrastructure. Here, the cloud network 10 may be configured using a 3G network, a 4G or Long Term Evolution (LTE) network, a 5G network, or the like.

That is, each device 100a to 100e, 200 constituting the AI system 1 can be connected to each other through the cloud network 10. In particular, each device 100a to 100e, 200 can communicate with each other through the base station, but can also communicate with each other directly without going through the base station.

The AI server 200 can include a server that performs AI processing and a server that performs calculations on big data.

The AI server 200 is connected to at least one or more of the AI devices constituting the AI system 1, such as a robot 100a, an autonomous vehicle 100b, an XR device 100c, a smartphone 100d, or a home appliance 100e, through the cloud network 10, and can assist at least a part of the AI processing of the connected AI devices 100a to 100e.

At this time, the AI server 200 can train an artificial neural network according to a machine learning algorithm on behalf of the AI device 100a to 100e, and can directly store the learning model or transmit the learning model to the AI device 100a to 100e.

At this time, the AI server 200 can receive input data from the AI device 100a to 100e, infer a result value for the received input data using the learning model, generate a response or control command based on the inferred result value, and transmit it to the AI device 100a to 100e.

Alternatively, the AI device 100a to 100e can directly infer a result value for the input data using the learning model, and generate a response or control command based on the inferred result value.

Hereinafter, various embodiments of the AI device 100a to 100e to which the above-described technology is applied will be described. Here, the AI devices 100a to 100e illustrated in FIG. 3 can be considered as specific examples of the AI device 100 illustrated in FIG. 1.

The XR device 100c can be implemented as a Head-Mounted Display (HMD), a Head-Up Display (HUD) equipped in a vehicle, a television, a mobile phone, a smart phone, a computer, a wearable device, a home appliance, a digital signage, a vehicle, a fixed robot or a mobile robot, etc. by applying AI technology.

The XR device 100c can obtain information about the surrounding space or a real object by analyzing 3D point cloud data or image data acquired through various sensors or from an external device to generate location data and attribute data for 3D points, and can render and output an XR object to be output. For example, the XR device 100c can output an XR object including additional information about the recognized object corresponding it to the recognized object.

The XR device 100c can perform the above-described operations using a learning model composed of at least one artificial neural network. For example, the XR device 100c can recognize a real object from 3D point cloud data or image data using the learning model, and provide information corresponding to the recognized real object. Here, the learning model may be learned directly in the XR device 100c or learned from an external device such as an AI server 200.

At this time, the XR device 100c may generate a result using the learning model directly and perform the operation, but may also transmit sensor information to an external device such as an AI server 200 and receive the result generated accordingly and perform the operation.

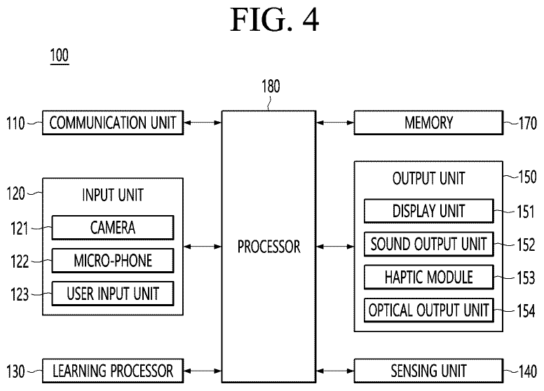

FIG. 4 illustrates an AI device 100 according to an embodiment of the present disclosure.

Descriptions overlapping with FIG. 1 are omitted.

Referring to FIG. 4, the input unit 120 may include a camera (Camera, 121) for inputting a video signal, a microphone (Microphone, 122) for receiving an audio signal, and a user input unit (User Input Unit, 123) for receiving information from a user.

Voice data or image data collected by the input unit 120 may be analyzed and processed as a user control command.

The input unit 120 is for inputting video information (or signal), audio information (or signal), data, or information input from a user. For inputting video information, the AI device 100 may be equipped with one or more cameras 121.

The camera 121 processes image frames such as still images or moving images obtained by an image sensor in a video call mode or a shooting mode. The processed image frames may be displayed on a display unit (Display Unit, 151) or stored in a memory 170.

The microphone 122 processes an external acoustic signal into electrical voice data. The processed voice data can be utilized in various ways depending on the function being performed (or the application being executed) in the AI device 100. Meanwhile, various noise removal algorithms can be applied to the microphone 122 to remove noise generated in the process of receiving an external acoustic signal.

The user input unit 123 is for receiving information from a user, and when information is input through the user input unit 123, the processor 180 can control the operation of the AI device 100 to correspond to the input information.

The user input unit 123 may include a mechanical input means (or a mechanical key, for example, a button located on the front/rear or side of the terminal 100, a dome switch, a jog wheel, a jog switch, etc.) and a touch input means. As an example, the touch input means may be composed of a virtual key, a soft key, or a visual key displayed on a touch screen through software processing, or may be composed of a touch key placed on a part other than the touch screen.

The output unit 150 may include at least one of a display unit 151, a sound output unit 152, a haptic module 153, and an optical output unit 154.

The display unit 151 displays (outputs) information processed in the AI device 100. For example, the display unit 151 may display execution screen information of an application program running in the AI device 100, or User Interface (UI) or Graphical User Interface (GUI) information according to such execution screen information.

The display unit 151 can implement a touch screen by forming a mutual layer structure with the touch sensor or by forming it as an integral part. This touch screen can function as a user input unit 123 that provides an input interface between the AI device 100 and the user, and at the same time, can provide an output interface between the terminal 100 and the user.

The audio output unit 152 can output audio data received from the communication unit 110 or stored in the memory 170 in a call signal reception mode, a call mode or a recording mode, a voice recognition mode, a broadcast reception mode, etc.

The sound output unit 152 may include at least one of a receiver, a speaker, and a buzzer.

The haptic module 153 generates various tactile effects that the user can feel. A representative example of the tactile effect generated by the haptic module 153 may be vibration.

The light output unit 154 outputs a signal to notify the occurrence of an event using the light of the light source of the AI device 100. Examples of events generated by the AI device 100 may include message reception, call signal reception, missed call, alarm, schedule notification, email reception, information reception through an application, etc.

Hereinafter, an AI-based plant cultivation control system (hereinafter referred to as a “plant cultivation control system” for convenience of explanation) is described.

Recently, the number of users who want to grow plants directly using a plant cultivation machine is increasing. These users are not only interested in the results of plant cultivation, but also have expectations about the cultivation process of a companion plant, such as a desired plant, just like a pet. Normally, when a seed kit is inserted into a plant cultivation machine, it takes about 4 to 6 weeks until the cultivation period, and the user may feel that this period is long, which may cause them to lose interest in plant cultivation. Therefore, in this disclosure, in addition to the automatic control function of the plant cultivation machine, even non-expert users are provided with prediction information about the future growth process of the target plant during the cultivation period, thereby providing a service to induce enjoyment and interest in using a plant cultivation machine or growing plants, and to enable virtual experiences.

As AI technology is applied or grafted into various fields, AI technology can also be used in a plant cultivation control system such as this disclosure. In this disclosure, by using a model generated based on artificial intelligence, prediction data (e.g., video or image) on the growth process or growth value of a plant by period is provided, thereby attracting the interest of users using a plant cultivation device and increasing convenience.

Meanwhile, a plant cultivation device has one purpose of creating an optimal environment for growing fresh plants in a relatively short period of time. Accordingly, in this disclosure, image data on a target plant (or all plants) in an artificial intelligence-based plant cultivation device is acquired, and a system is built and provided to automatically optimize various types of plant cultivation environments based on a machine learning recognition model, and furthermore, a system capable of preventing diseases that may occur during the cultivation process is provided, thereby increasing user satisfaction with the service.

In the present disclosure, for artificial intelligence-based plant cultivation control, the following embodiments are described.

First, this disclosure can provide prediction information on the growth process or growth value of a target plant by period using a model generated based on artificial intelligence. Such prediction information can be provided as image data. To this end, the present disclosure can provide a period-based growth image of a target plant based on a future prediction generation model described later as an AI-based generation model. In addition, the present disclosure can also provide information on changes in the plant growth status according to adjustment of the plant growth environment values (e.g., external temperature, humidity, soil, light source, ventilation, etc.) set in a plant cultivation device using an AI-based generation model. Information on changes in the plant growth status can also be provided as image data. However, the present disclosure is not limited to the above-described examples.

Meanwhile, the present disclosure can provide an AI service based on a machine learning recognition model for image data of a target plant in a plant cultivation device. For example, the present disclosure can provide an AI service for automatically optimizing the cultivation environment for a target plant in a plant cultivation device, a notification for determining whether or not a target plant is sick or a user guide (e.g., whether pruning is necessary for the target plant), and an AI service for selecting a cultivation/harvest time or a harvestable plant (or leaves or fruits, etc.). Here, image data for the target plant in the plant cultivation device can be acquired through an image acquisition device, and such an image acquisition device may include an image sensor built into the plant cultivation device or an external image sensor of the plant cultivation device or a user's terminal equipped with an image sensor.

The present disclosure can be applied not only to small plant cultivation devices but also to medium-to large-sized plant cultivation devices or systems such as smart farms. However, for convenience of explanation, a plant cultivation device is taken as an example.

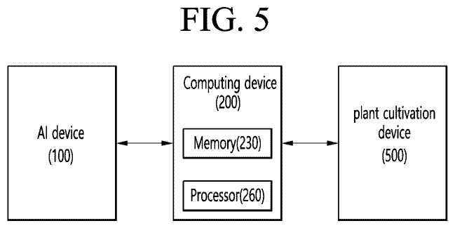

FIG. 5 is a drawing illustrating an artificial intelligence-based plant cultivation control system according to an embodiment of the present disclosure.

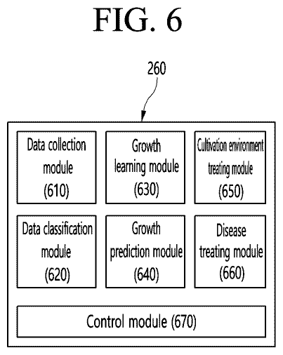

FIG. 6 is a block diagram illustrating the operation of the processor 260 of FIG. 5.

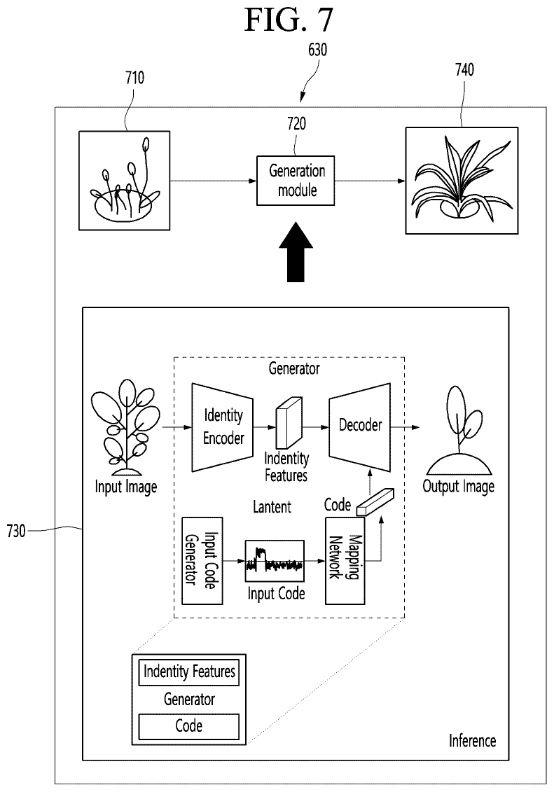

FIG. 7 is a block diagram illustrating the operation of the learning unit 630 of FIG. 6.

An AI-based plant cultivation control system according to at least one of the various embodiments of the present disclosure may include a plant cultivation device 500 and a computing device (e.g., an AI server) 200 that communicates with the plant cultivation device to exchange signals. At this time, the computing device 200 may include a processor 260 that generates a plant growth prediction model, acquires an image of a target plant in the plant cultivation device 500 when an event is detected, generates cultivation information of the target plant for the detected event and the acquired image based on the plant growth prediction model, and controls the output of the generated cultivation information of the target plant.

Referring to FIG. 5, the plant cultivation control system may be configured to include an AI device 100, a computing device (AI server) 200, and a plant cultivation device 500. Depending on the embodiment, the plant cultivation control system may be configured to include one or more additional components in addition to the illustrated configuration.

The AI device 100 may be a terminal of a user who grows plants through a plant cultivator 500.

The AI device 100 may include or be linked to various output interfaces. These output interfaces may include a display that outputs a screen for various information generated by a computing device 200, a speaker that outputs sound, etc. The display may provide a user interface (UI) necessary for a terminal user to make a request, control, provide a result according to a request, etc. related to the control of the plant cultivator 500.

Some screens of the AI device 100 may output corresponding information or results when a user executes or controls a function through a button provided on the plant cultivator 500, or when a display is not employed in the plant cultivator 500.

As described above, the AI device 100 may be a fixed terminal such as a PC, DTV, or digital signage, or a mobile terminal such as a smartphone, tablet PC, laptop, or wearable device.

If the AI device 100 supports an augmented reality (AR) function or an augmented reality application or program, it may provide various information disclosed in the present disclosure about a target plant in the plant cultivator 500 to the user as an augmented reality screen. The present disclosure is not limited thereto, and may also be applied to extended reality (XR: extended Reality), including not only augmented reality but also virtual reality (VR: Virtual Reality), mixed reality (MR: Mixed Reality).

The plant cultivator 500 may be connected to the AI device 100 and the computing device 200 through a wired/wireless communication protocol, and may exchange signals containing various information.

The plant cultivation device 500 can include or detachably attach various sensors on or inside the housing, and can sense or acquire various information through them. These sensors may include an image sensor, a temperature sensor, a humidity sensor, a light sensor, etc. At least one side of the housing may be implemented with a transparent display or made of transparent glass so that the inside can be seen.

In FIG. 6, a detailed configuration block of a processor 260 constituting a computing device 200 is illustrated.

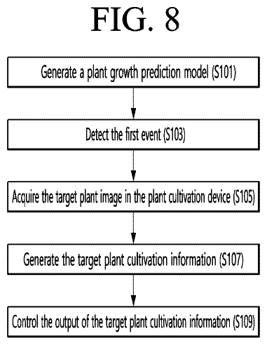

The processor 260 may perform or control operations related to FIGS. 8 to 15 described below.

Referring to FIG. 6, the processor 260 may be configured to include a data collection module 610, a data classification module 620, a learning module 630, and a control module 670.

The processor 260 may further include a growth prediction module 640, a cultivation environment processing module 650, a disease processing module 660, etc. However, depending on the embodiment, the growth prediction module 640, the cultivation environment processing module 650, the disease processing module 660, etc. may not be included as components of the processor 260, but the functions performed by the corresponding modules may be performed by the control module 670.

The data collection module 610 can collect various data related to plant growth (cultivation). The data collection module 610 can collect plant growth data for artificial intelligence learning from an external source through a communication module (not shown) or can directly receive growth data of a target plant from an AI device 100.

The data classification module 620 can classify and process plant growth data collected or received through the data collection module 610 so that the learning module 630 can learn it. The data classification module 620 can preprocess the received data for classification processing.

The control module 670 can control data collected or received through the data collection module 610 to be stored in the memory 230 shown in FIG. 5, or control data classified by the data classification module 620 to be stored in the memory 230.

The learning module 630 can learn plant growth data input through the data classification module 620 based on a pre-generated learning model.

FIG. 7 is illustrated to explain the operation of the learning module 630 according to an embodiment of the present disclosure.

The operation of the learning module 630 can largely include training, that is, a learning process and an inference process.

The learning module 630 can learn plant growth data using a training process, for example, a pre-generated learning model, to generate a future prediction model 730.

FIG. 7 illustrates a future prediction model 730 for performing an inference process.

Referring to FIGS. 6 and 7, the learning module 630 can generate a virtual plant growth image from the plant growth future prediction image generation model 720 using the input data and the future prediction model 730.

The input data may include a target plant image, target plant growth environment information, and future prediction period information of the target plant. The target plant growth environment information may include, for example, the internal temperature, humidity, soil composition, and light source information of the plant cultivation device 500. The future prediction period information of the target plant may include time information, which is for the user to check the growth status of the target plant at a certain point in the future, and an arbitrary time (for example, one week later, two weeks later, one month later, etc.) may be set.

The plant growth future prediction image generation model may generate virtual growth prediction image data 740 of the corresponding time or period based on the aforementioned input data and the future prediction model 730.

In the present disclosure, in relation to the construction or generation of the future prediction model 730, specific descriptions may refer to known technologies. At this time, the known technologies relate to a model that generates age-based images based on faces. However, the present disclosure does not use known technologies as they are, and instead of face images, images of target plants that are the subject of the present disclosure may be used. In addition, instead of age (age) regarding growth, desired future growth prediction intervals or time information may be used as input in the present disclosure.

According to one embodiment of the present disclosure, multiple output images, i.e., predicted virtual image data, may be generated based on one input image. At this time, each output image may be expected image data for a specific period or may be expected image data for different periods.

When learning is completed in the learning module 630 and the image generation model 720 of FIG. 7 is generated, the growth prediction module 640 may generate future growth prediction virtual images for the target plant based on the input data as described above.

The cultivation environment processing module 650 can process cultivation environment information of the target plant in the plant cultivation device 500. The cultivation environment processing module 650 can operate based on the result data of the growth prediction module 640 described above, that is, the generated virtual image of future growth prediction for the target plant and data related to cultivation environment among the input data thereof.

The disease processing module 660 can process disease information of the target plant in the plant cultivation device 500. The disease processing module 660 can operate based on the result data of the growth prediction module 640 described above, that is, the generated virtual image of future growth prediction for the target plant and data related to disease among the input data thereof.

The operation described above can include at least one of generation, transmission, etc. of control information for cultivation environment control or disease treatment control.

The control module 670 can control the overall operation of the processor 260 and can also exchange data between the memory 230. The control module 670 can control the operation of the components or specific components illustrated in FIGS. 6 and 7.

The AI-based plant cultivation control method will be described in more detail with reference to the attached drawings.

FIGS. 8 to 12 are flowcharts illustrating the AI-based plant cultivation control method according to an embodiment of the present disclosure.

Referring to FIG. 8, an embodiment of a method for controlling AI-based plant cultivation in a computing device 200 may be performed as follows.

The computing device 200 may generate a plant growth prediction model (S101).

The computing device 200 may detect a first event (S103).

The computing device 200 may acquire an image of a target plant in a plant cultivation device (S105).

The computing device 200 may generate cultivation information of the target plant for the detected first event and the acquired image based on the plant growth prediction model (S107).

The computing device 200 can control the output of the cultivation information of the target plant generated above (S109).

The computing device 200 can collect plant growth data, preprocess the collected plant growth data, and learn the preprocessed plant growth data based on a predefined future prediction generation model in relation to step S101.

Meanwhile, in the present disclosure, the cultivation information of the target plant may include at least one of plant growth prediction image information, plant cultivation environment setting information, plant disease presence/absence information, cultivation time information, and selection information for a part of a plant that can be cultivated, but is not necessarily limited thereto.

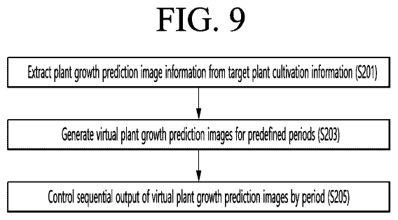

Next, referring to FIG. 9, the computing device 200 can extract plant growth prediction image information from the cultivation information of the target plant according to the first event detected (S201).

The computing device 200 can generate a virtual plant growth prediction image for a predefined period unit based on the extracted plant growth prediction image information (S203).

The computing device 200 can control the generated virtual plant growth prediction image to be sequentially output for a period unit (S205).

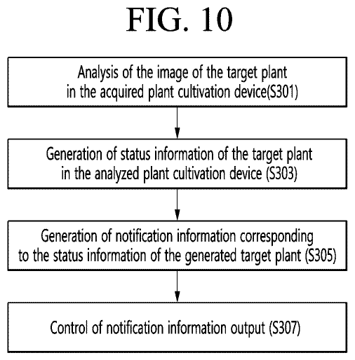

Next, referring to FIG. 10, the computing device 200 can analyze the image of the target plant in the acquired plant cultivation device according to the detected first event (S301).

The computing device 200 can generate status information of the target plant in the analyzed plant cultivation device (S303).

The computing device 200 can generate notification information corresponding to the generated status information of the target plant (S305).

The computing device 200 can control the generated notification information to be output (S307).

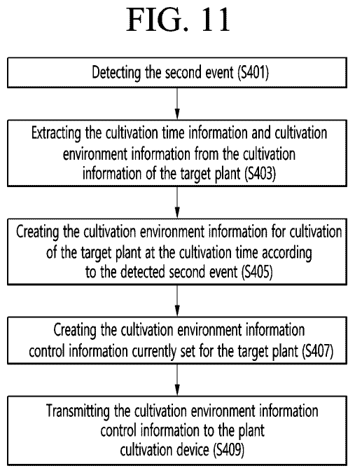

Next, referring to FIG. 11, the computing device 200 can detect a second event (S401).

The computing device 200 can extract cultivation time information and cultivation environment information from the cultivation information of the target plant (S403).

The computing device 200 can calculate cultivation environment information for cultivation of the target plant at the cultivation time according to the second event detected based on the extracted cultivation time information and cultivation environment information of the target plant (S405).

The computing device 200 can generate cultivation environment information control information currently set for the target plant based on the generated cultivation environment information (S407).

The computing device 200 can transmit the generated cultivation environment information control information to the plant cultivation machine (S409).

Here, at least one of the events in the aforementioned FIG. 8 and FIG. 11 can be received from one of a predetermined button provided on the plant cultivator 500, a first mobile device having a plant cultivation control application installed, and a second mobile device linked with the first mobile device.

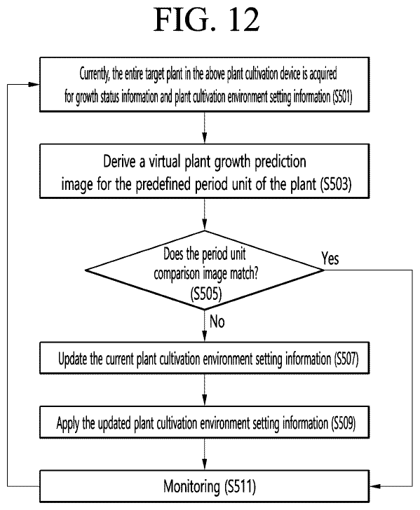

Finally, referring to FIG. 12, the computing device 200 can obtain information on the growth status of the entire target plant in the current plant cultivator 500 and information on setting the plant cultivation environment (S501).

The computing device 200 can derive a virtual plant growth prediction image of a predefined period unit of the corresponding plant based on the acquired growth status information of the entire target plant and the plant cultivation environment setting information (S503).

The computing device 200 can compare the derived current virtual plant growth prediction image for the target plant with the virtual plant growth prediction image for the target plant generated according to the previous event by period unit (S505).

The computing device 200 can analyze the comparison results and update the current plant cultivation environment setting information (S507).

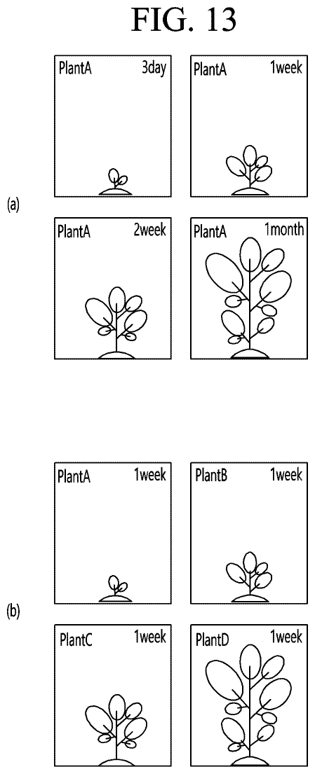

FIG. 13 to t 15 are drawings illustrating a user interface related to an AI-based plant cultivation control according to an embodiment of the present disclosure.

FIGS. 13 to 15 may be user interface screens related to the method of FIGS. 8 to 12 described above.

FIG. 13 illustrates a virtual growth prediction image for a target plant by period unit.

Referring to FIG. 13(a), a computing device 200 can provide a growth prediction image of a target plant for 3 days, 1 week, 2 weeks, and 1 month from the present to an AI device 100.

Referring to FIG. 13(a), identifier information (e.g., plant A) that can identify a target plant may be provided in the upper area of each image, and period information (e.g., 3 days, 1 week, 2 weeks, 1 month, etc.) may be provided in another area.

When a signal for selecting identifier information is received from the AI device 100, the computing device 200 may provide a list of plants for which growth prediction images can be provided, and may change and provide a growth prediction image of a plant selected from the plant list.

Meanwhile, when a signal for selecting period information is received from the AI device 100, the computing device 200 may provide a list of selectable periods, and may change and provide a growth prediction image of a period selected from the period list.

According to the embodiment, four virtual growth prediction images for a period unit for one target plant are provided on each user interface screen of FIG. 13(a), but when a request for changing period information is received on one of the growth prediction images, the computing device 200 may automatically change the period of the remaining growth prediction images accordingly and provide them as growth prediction images corresponding to the corresponding period.

Meanwhile, unlike as shown in FIG. 13(a), each user interface screen provides virtual growth prediction images for one period, i.e., the same period, but the target plants corresponding to each image may be different, as shown in FIG. 13(b).

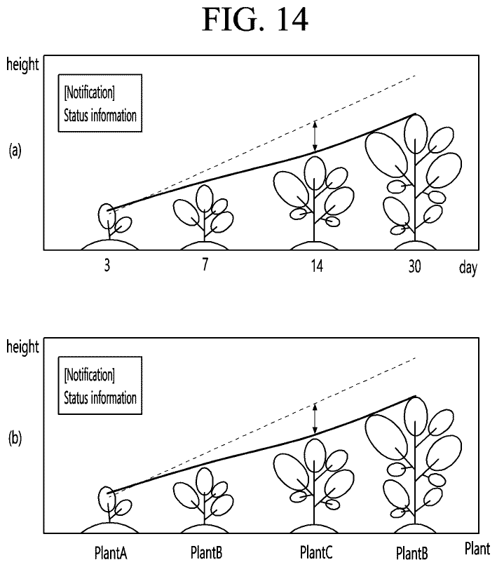

Unlike FIG. 13, in FIG. 14, a virtual growth prediction image of a target plant may be provided with one user interface.

In the graph shown in FIG. 14(a), the horizontal axis may represent the period and the vertical axis may represent the height (growth level).

In FIG. 14(a), the computing device 200 can provide status information by providing a solid line connecting each virtual growth prediction image for the target plant and a dotted line indicating a level predicted to be able to grow to the maximum (Max) when the optimal cultivation environment setting is followed.

In FIG. 14(a), the computing device 200 can provide a virtual growth prediction image after each period has elapsed based on the current cultivation environment setting.

The computing device 200 can indicate that growth promotion is possible for the target plant by changing the cultivation environment setting on the graph shown in FIG. 14(a).

When the user selects a dotted line or solid line or requests a cultivation environment change setting through the AI device 100 in FIG. 14(a), the computing device 200 can provide the current cultivation environment setting information corresponding to the solid line and the cultivation environment setting information corresponding to the dotted line together so that they can be compared. At this time, the computing device 200 can blank out items that do not require change, and can differentiate items that require change or are necessarily requested to be changed (e.g., disease concerns, etc.).

According to the embodiment, the computing device 200 can control the requested cultivation environment change setting to be made from the corresponding period when a specific period is selected in FIG. 14(a) and the requested cultivation environment change setting is requested.

FIG. 14 (b) can be viewed as a user interface screen corresponding to FIG. 13(b), and all of the contents disclosed in FIG. 14(a) described above can be applied equally.

Meanwhile, FIG. 13(b) and FIG. 14(b) can be adopted, for example, when there are multiple plants being grown in one or the same plant cultivation device 500.

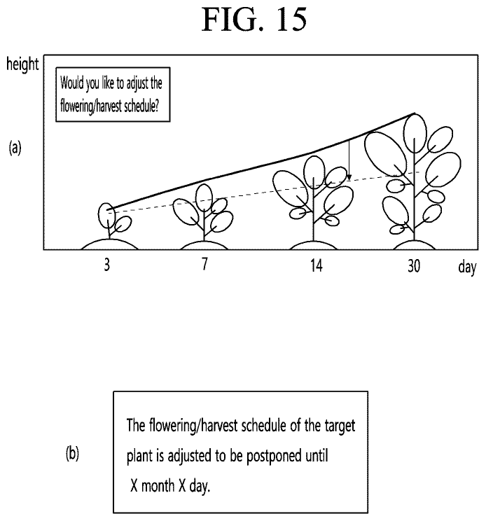

FIG. 15 is a user interface illustrated to explain the control of adjusting the flowering/harvesting time.

Referring to FIG. 15(a), unlike FIGS. 13 and 14, the computing device 200 is a control scenario for adjusting the flowering/harvesting time, not promoting the growth of the target plant.

The computing device 200 may provide a message guiding that the solid line can be moved when the solid line is selected by the AI device 100 in the user interface of FIG. 15(a).

FIG. 15(a) can be viewed as an example of a case where the solid line is moved downward by providing a guidance message such as “Do you want to adjust the flowering/harvesting time?” as illustrated, for example. However, it is not limited thereto.

In other words, when a solid line is selected in the user interface illustrated in FIG. 15(a), the computing device 200 can guide that the solid line can move, and can provide the solid line to move in any direction, up, down, left, or right.

When the solid line moves to a different location than before, the computing device 200 can determine the moving location relative to the reference line (solid line) and provide a corresponding guidance message again, as in FIG. 15(b). At this time, the guidance message can include guidance on changes in flowering/harvesting time due to movement, guidance on expected flowering/harvesting time, guidance on changes in cultivation environment settings due to changes, etc.

When a positive signal or an agreement signal is received in the guidance message according to FIG. 15(b), the computing device 200 can extract cultivation environment setting information to be changed accordingly, and finally change the cultivation environment settings.

In FIG. 15, one target plant is used as an example for convenience of explanation, but as described above, this can be applied to multiple target plants as well, and batch setting change processing can also be performed as needed.

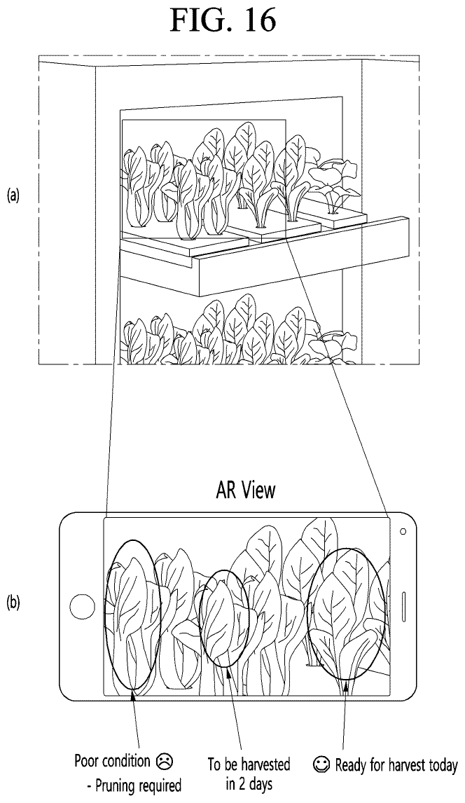

FIG. 16 is a drawing illustrating a scenario for providing information on target plant cultivation based on artificial intelligence according to an embodiment of the present disclosure.

FIG. 16(a) illustrates a plant cultivation machine 500 in which multiple plants are being cultivated.

As in FIG. 16(b), when the AI device 100 focuses (or captures) a predetermined space or a predetermined plant in FIG. 16(a), the computing device 200 can select a target area and provide status information on each target plant included in the selected target area.

Referring to FIG. 16(b), the computing device 200 can provide marking information on a target plant that is in a bad condition and needs pruning, marking information on a target plant that can be harvested in two days, and marking information on a target plant that can be harvested today as an augmented reality view (AR view) output from the AI device 100.

The augmented reality view of FIG. 16(b) may include differentiated content so that the user can easily recognize and identify the state of each target plant through the AI device 100. For the convenience of identification, the augmented reality view of FIG. 16(b) may provide various additional information such as text, audio, and emoji.

The computing device 200 may separately monitor target plants viewed in the augmented reality view, as shown in FIG. 16(b), and target plants selected or accessed in the augmented reality view.

The order of operations described in the present disclosure is not necessarily bound to the order described in the drawings or in the specification, and some operations may be performed together or in a different order than that depicted depending on the embodiment.

According to at least one of the various embodiments of the present disclosure described above, the convenience of using a plant cultivation machine can be improved through various plant cultivation control information including information on growth prediction Of a target plant based on artificial intelligence, and a virtual experience service can be provided based on the automatic control function of the plant cultivation machine and prediction information on the future growth process of the target plant during the cultivation period, so that even non-experts can use the plant cultivation machine easily and conveniently, and also maximize the service quality by inducing enjoyment and interest in plant cultivation.

According to one embodiment of the present invention, the above-described method can be implemented as a code that can be read by a processor in a medium in which a program is recorded. Examples of the medium that can be read by a processor include ROM, RAM, CD-ROM, magnetic tape, floppy disk, optical data storage device, etc.

The display device described above is not limited to the configuration and method of the embodiments described above, and the embodiments can be configured by selectively combining all or part of each embodiment so that various modifications can be made.

### Industrial Applicability

According to the artificial intelligence-based plant cultivation control according to the present disclosure, not only the virtual growth prediction information of the plant but also various information or information on control required for plant cultivation are provided, so that even non-experts can easily and conveniently perform plant cultivation, thereby maximizing service satisfaction, and it can be applied or grafted onto various plant cultivation devices, so it has industrial applicability.

What is claimed is:

1. A method for controlling plant cultivation based on artificial intelligence in a server, comprising:
generating a plant growth prediction model;
detecting a first event;
obtaining an image of a target plant in a plant cultivation device;
generating cultivation information of a target plant for the detected first event and the obtained image based on the plant growth prediction model; and
controlling an output of the generated cultivation information of the target plant.

2. The method according to claim 1, wherein the step of generating the plant growth prediction model comprises:
collecting plant growth data;
preprocessing the collected plant growth data; and
learning the preprocessed plant growth data based on a predefined future prediction generation model.

3. The method according to claim 2, wherein the cultivation information of the target plant includes at least one of plant growth prediction image information, plant cultivation environment setting information, plant disease presence/absence information, cultivation time information, and selection information for a portion of a plant that is capable of being cultivated.

4. The method according to claim 3, further comprising:
extracting, according to the detected first event, plant growth prediction image information in the cultivation information of the target plant;
generating a virtual plant growth prediction image of a predefined period unit based on the extracted plant growth prediction image information; and
controlling the generated virtual plant growth prediction image to be sequentially output in period units.

5. The method according to claim 4, further comprising:
analyzing, according to the detected first event, the obtained image of the target plant in the plant cultivation device;
generating status information of the analyzed target plant in the plant cultivation device;
generating notification information corresponding to the generated status information of the target plant; and
controlling the generated notification information to be output.

6. The method according to claim 5, further comprising:
detecting a second event;
extracting the cultivation time information and the cultivation environment information from the cultivation information of the target plant;
calculating cultivation environment information for cultivation of the target plant at a cultivation time according to the detected second event based on the extracted cultivation time information and the cultivation environment information of the target plant;
generating cultivation environment information control information currently set for the target plant based on the calculated cultivation environment information; and
transmitting the generated cultivation environment information control information to the plant cultivation device.

7. The method according to claim 6, wherein at least one of the first event and the second event is received from one of a predetermined button provided on the plant cultivation device, a first mobile device having a plant cultivation control application installed, and a second mobile device linked with the first mobile device.

8. The method according to claim 7, further comprising:
obtaining growth status information and plant cultivation environment setting information of all target plants in the current plant cultivation device;
deriving a virtual plant growth prediction image of the predefined period unit of the corresponding plant based on the obtained growth status information and the plant cultivation environment setting information of the target plants;
comparing the derived current virtual plant growth prediction image of the target plant with the virtual plant growth prediction image of the target plant generated according to the previous event for the period unit; and
analyzing the comparison result and updating the current plant cultivation environment setting information.

9. A system for controlling plant cultivation based on artificial intelligence, comprising:
a plant cultivation device; and
a computing device communicating with the plant cultivation device and transmit and receive a signal,
wherein the computing device comprises a processor that generates a plant growth prediction model, obtains, when an event is detected, an image of a target plant in the plant cultivation device, generates cultivation information of the target plant for the detected event and the obtained image based on the plant growth prediction model, and controls an output of the generated cultivation information of the target plant.

10. The system according to claim 9, wherein the processor is configured to collect plant growth data, preprocess the collected plant growth data, and learn the preprocessed plant growth data based on a predefined future prediction generation model to generate the plant growth prediction model, and
wherein the cultivation information of the target plant includes at least one of plant growth prediction image information, plant cultivation environment setting information, plant disease presence/absence information, cultivation time information, and selection information for a portion of a plant that is capable of being cultivated.

11. The system according to claim 10, wherein the processor is configured to extract plant growth prediction image information in the cultivation information of the target plant according to the detected first event, generate a virtual plant growth prediction image of a predefined period unit based on the extracted plant growth prediction image information, and control the generated virtual plant growth prediction image to be sequentially output in the period unit.

12. The system according to claim 11, wherein the processor is configured to analyze the image of the target plant in the obtained plant cultivation device according to the detected first event, generate status information of the analyzed target plant in the plant cultivation device, generate notification information corresponding to the generated status information of the target plant, and control the generated notification information to be output.

13. The system according to claim 12, wherein the processor is configured to extract, when a second event is detected, cultivation time information and cultivation environment information from the cultivation information of the target plant, calculate cultivation environment information for cultivation 49 of the target plant at the cultivation time according to the detected second event based on the extracted cultivation time information and cultivation environment information of the target plant, generate cultivation environment information control information currently set for the target plant based on the calculated cultivation environment information, and transmit the generated cultivation environment information control information to the plant cultivation device.

14. The system according to claim 13, wherein at least one of the first event and the second event is received from one of a predetermined button provided on the plant cultivation device, a first mobile device having a plant cultivation control application installed, and a second mobile device linked with the first mobile device.

15. The system according to claim 14, wherein the processor is configured to
obtain the growth status information and the plant cultivation environment setting information of all target plants in the plant cultivation device at present,
derive a virtual plant growth prediction image of corresponding plant for the predefined period unit based on the obtained current growth status information and the plant cultivation environment setting information of the target plants,
compare the current virtual plant growth prediction image of the derived target plant with the virtual plant growth prediction image of the target plant generated according to the previous event for the period unit, and
analyze the comparison result to update the current plant cultivation environment setting information.
